(19) United States
(12) Patent Application Publication
(10) Pub. No.: US 2026/0230346 A1
(43) Pub. Date: Aug. 6, 2026

(54) BLOCKING AN UNAUTHORISED USER OR TAKING ANOTHER CORRECTIVE ACTION ACROSS ETHERNET VIRTUAL PRIVATE NETWORK (EVPN) FABRIC DURING RAPID MEDIA ACCESS CONTROL (MAC) MOVEMENT

(71) Applicant: Juniper Networks, Inc., Sunnyvale, CA (US)

(72) Inventors: Soumyodeep Joarder, Bangalore (IN); Pavana C. V, Bangalore (IN); Vasudevan Venkatraman, Bangalore (IN); Ezhilan Vulian Karunakaran, Ranipet dist-TamilNadu (IN); Santhosh Kumar Velu, Bangalore (IN)

(21) Appl. No.: 19/047,015

(22) Filed: Feb. 6, 2025

(51) Int. Cl. H04L 12/18; H04L 12/44; H04L 12/46; H04L 43/10

(52) U.S. Cl. CPC H04L 12/1886; H04L 12/44; H04L 12/4675; H04L 43/10

(57) ABSTRACT

The problem of wasted network bandwidth within an Ethernet Virtual Private Network (EVPN), in scenarios in which a provider edge (PE) device detects a duplicate MAC but only performs a corrective action (e.g., blocking traffic sourced from and/or destined to the duplicate MAC) locally (at the PE that determined the duplicate MAC), is solved by taking a corrective action with respect to the MAC across the EVPN fabric. This may be done by having the PE device that determined a duplicate MAC to advertise this fact to other PE devices in the EVPN. This advertisement may be, or may be included in, a Type-2 MAC advertisement route (for example, in a MAC Mobility Extended Community path attribute, such as a set bit in the flags field of a MAC Mobility Extended Community path attribute).

### § 1. BACKGROUND OF THE INVENTION

### § 1.1 Field of the Invention

The present application concerns network communications. In particular, the present application concerns potential security issues due to “MAC mobility” or “MAC move” in an Ethernet Virtual Private Network (EVPN).

### § 1.2 Background Information

Anything discussed in this section is not to be construed as an admission of prior art.

### § 1.2.1 INTRODUCTION TO EVPNs

The document A. Sajassi, Ed., “BGP MPLS-Based Ethernet VPN,” Request for Comments: 7432 (Internet Engineering Task Force, February 2015)(referred to as “RFC 7432” and incorporated herein by reference) describes procedures for border gateway protocol (BGP) multiprotocol label switch-based (MPLS-based) EVPNs. Although EVPNs and RFC 7432 are well-understood by those skilled in the art, the relevant sections of RFC 7432 are introduced below for the reader's convenience.

Virtual Private LAN Service (VPLS) is a proven and widely deployed technology. However, the existing solution has a number of limitations when it comes to multihoming and redundancy, multicast optimization, provisioning simplicity, flow-based load balancing, and multipathing. These limitations are important considerations for Data Center (DC) deployments. RFC 7432 addresses these limitations. More specifically, RFC 7432 describes procedures for a BGP MPLS-based solution called Ethernet VPN (EVPN) to address these limitations.

An EVPN instance comprises Customer Edge devices (CEs) that are connected to Provider Edge devices (PEs) that form the edge of the MPLS infrastructure (e.g., an MPLS transport network, a data center, etc.). A CE may be a host, a router, or a switch. The PEs provide virtual Layer 2 bridged connectivity between the CEs. There may be multiple EVPN instances in the provider's network.

The PEs may be connected by an MPLS Label Switched Path (LSP) infrastructure, which provides the benefits of MPLS technology, such as fast reroute, resiliency, etc. The PEs may also be connected by an IP infrastructure, in which case IP/GRE (Generic Routing Encapsulation) tunnelling or other IP tunnelling can be used between the PEs.

In an EVPN, learning between PEs and CEs is done by the method best suited to the CE: data-plane learning, IEEE 802.1x, the Link Layer Discovery Protocol (LLDP), IEEE 802.1aq, Address Resolution Protocol (ARP), management plane, or other protocols. However, Media Access Control (MAC) learning between PEs occurs not in the data plane (as happens with traditional bridging in VPLS), but rather, in the control plane (e.g., using BGP). (See § 1.2.1.1 below.) Control-plane learning offers greater control over the MAC learning process, such as restricting who learns what, and the ability to apply policies. Furthermore, the control plane chosen for advertising MAC reachability information is multi-protocol (MP) BGP. This provides flexibility and the ability to preserve the “virtualization” or isolation of groups of interacting agents (hosts, servers, virtual machines) from each other. In EVPN, PEs advertise the MAC addresses learned from the CEs that are connected to them, along with an MPLS label, to other PEs in the control plane using Multiprotocol BGP (MP-BGP). Control-plane learning enables load balancing of traffic to and from CEs that are multihomed to multiple PEs. This is in addition to load balancing across the MPLS core (e.g., transport network, data center, etc.) via multiple label switched paths (LSPs) between the same pair of PEs. In other words, it allows CEs to connect to multiple active points of attachment. It also improves convergence times in the event of certain network failures.

### § 1.2.1.1 BGP EVPN ROUTES AND TYPE-2 EVPN ROUTES

Section 7 of RFC 7432 defines a new BGP Network Layer Reachability Information (NLRI) called the EVPN NLRI. FIG. 1 illustrates the format of the EVPN NLRI 100, which is carried in an MP_REACH_NLRI/MP_UNREACH_NLRI 110. As shown, the Route Type field 102 defines the encoding of the rest of the EVPN NLRI (Route Type specific EVPN NLRI). Four route types are introduced below. The Length field 104 indicates the length in octets of the Route Type specific field 106 of the EVPN NLRI 100. RFC 7432 defines the following Route Types:
1-Ethernet Auto-Discovery (A-D) ROUTE;
2-MAC/IP Advertisement route;
3-Inclusive Multicast Ethernet Tag route; and
4-Ethernet Segment route.

The EVPN NLRI 100 is carried in BGP using BGP Multiprotocol Extensions as defined in the document, T. Bates, et al., “Multiprotocol Extensions for BGP-4,” Request for Comments: 4760 (Internet Engineering Task Force (IETF), January 2007) (referred to as “RFC 4760” and incorporated herein by reference) in a multiprotocol reachable NLRI (MP_REACH_NLRI) attribute 110 with a type field 120 carrying 14 for MP_REACH_NLRI or 15 for MP_UNREACH_NLRI, a field 130 carrying the length of the next hop address, field 140 carrying an Address Family Identifier (AFI) of 25 (for L2VPN), a field 150 carrying a Subsequent Address Family Identifier (SAFI) of 70 (for EVPN), and a field 160 carrying the next-hop address within the NLRI (e.g., the IP address of the PE (or VTEP) advertising the EVPN route). The NLRI field in the MP_REACH_NLRI / MP_UNREACH_NLRI attribute 110 contains the EVPN NLRI 100.

EVPN BGP Type 2 advertisements (Ethernet Segment Route advertisements) are used for distributing Media Access Control (MAC) address information. These advertisements provide details about MAC addresses that are reachable within the EVPN instance. These advertisements include the MAC address, the associated IP address (if applicable), and the Ethernet VPN Route Distinguisher (RD). They also specify the attached devices and the Ethernet segment they belong to. These advertisements facilitate MAC address learning and providing connectivity, and enable traffic to reach the right destination within the EVPN, ensuring that MAC addresses are mapped correctly to the right VPN instance. Referring to FIG. 2, MAC/IP Advertisement route type specific EVPN NLRI 106′ includes an 8-octet route distinguisher (RD) field 210, a 10-octet Ethernet Segment Identifier (ESI) field 220, a 4-octet Ethernet Tag ID field 230, a 1-octet MAC Address Length field 240, a 6-octet MAC Address field 250, a 1-octet IP Address Length field 260, a 0, 4, or 16-octet IP Address field 270, a 3-octet MPLS Label 1 field 280, and a 0 or 3-octet MPLS Label 2 field 290. For the purpose of BGP route key processing, only the Ethernet Tag ID 230, MAC Address Length 240, MAC Address 250, IP Address Length 260, and IP Address 270 fields are considered to be part of the prefix in the NLRI. The Ethernet Segment Identifier 220, MPLS Label 1 280, and MPLS Label 2 290 fields are to be treated as route attributes as opposed to being part of the “route”. Both the IP and MAC address lengths are in bits.

Section 7.5 of RFC 7432 describes the ESI Label Extended Community, which is a transitive Extended Community. Each ESI Label extended community is encoded as an 8-octet value and has a Type field value of 0x06 and the Sub-Type 0x01, a 1-octet Flags field and a 32-bit ESI label.

Referring back to 210 of FIG. 2, a route distinguisher (RD) in EVPN is a unique identifier that allows identical IP prefixes in different VPNs to be differentiated. The RD helps to maintain the isolation of VPN services (e.g., by helping to ensure that VPN routes are unique within a routing table), while enabling the sharing of the same IP address space among multiple customers or instances. This allows the BGP control plane to maintain separate routing tables for each VPN, ensuring traffic remains isolated. The RD may be set to the RD of the MAC-VRF that is advertising the NLRI. An RD is assigned for a given MAC-VRF on a PE. The RD is unique across all MAC-VRFs on a PE. The value field comprises an IP address of the PE (typically, the loopback address) and a (appended or prepended) number unique to the PE.

### § 1.2.1.2 MAC MOBILITY

### § 1.2.1.2.1 Mac Mobility Extended Community

Per section 7.7 of RFC 7432, and as illustrated in FIG. 3, a MAC Mobility Extended Community is a new transitive Extended Community. The MAC Mobility Extended Community may be advertised along with MAC/IP Advertisement (Type-2) routes. As shown, the MAC Mobility Extended Community has a Type field 310, a Sub-Type field 320, a Flags(1-octet) field 330, a reserved field 340, and a Sequence Number field 350. The Type field 310 has a value of 0x06. The Sub-Type field 320 has a value of 0x00. The low-order bit of the Flags field 330 is defined as the “Sticky/static” flag and may be set to 1. A value of “1” means that the MAC address in the Type-2 route advertisement is static and cannot move. The value in the sequence number field 350 is used to ensure that PEs retain the correct (e.g., most recent) MAC/IP Advertisement route when multiple updates occur for the same MAC address. The procedures for using the MAC Mobility Extended Community are described in section 15 of RFC 7432.

### § 1.2.1.2.1 Mac Mobility Processing

A given host or end-station (as defined by its MAC address) can move from one Ethernet segment to another. This is referred to as “MAC Mobility” or “MAC move” (which is different from a multihoming situation in which a given MAC address is reachable via multiple PEs for the same Ethernet segment). In a MAC move, there would be two sets of MAC/IP Advertisement routes: (i) one set with the new Ethernet segment; and (ii) another set with the previous Ethernet segment. Without careful processing of the Type-2 route advertisement, the MAC address might appear to be reachable via each of these Ethernet segments, which is not the case. To allow all of the PEs in the EVPN instance to determine the current (that is, the correct) location of the MAC address, all advertisements of it being reachable via the previous Ethernet segment are withdrawn by the PEs that had advertised the previous Ethernet segment.

If local learning were to be performed using the data plane, these PEs would not be able to detect that the MAC address has moved to another Ethernet segment. To rectify this, the receipt of MAC/IP Advertisement routes with the MAC Mobility extended community attribute (in which a more recent ESI (Recall 220 of FIG. 2.) is indicated by a sequence number (Recall 350 of FIG. 3.)) triggers the PE to withdraw its MAC/IP (Type-2) advertised routes, since such routes have stale ESI information. Thus, if local learning is performed using the control or management planes, these interactions serve as the trigger for any PE(s) that have advertised an older ESI in association with the MAC address, to withdraw their advertisements.

If there are multiple moves of a given MAC (possibly between the same two Ethernet segments), there may be multiple withdrawals and re-advertisements. To ensure that all PEs in the EVPN instance receive all of these correctly through the intervening BGP infrastructure, the sequence number (Recall 350 of FIG. 3.) is used. (Note that to process mobility events correctly, scenarios in which sequence number wraparound occur are accounted for.)

Referring back to field 350 of FIG. 3, per section 15 of RFC 7432, every MAC mobility event for a given MAC address will contain a sequence number that is set using the following rules:
A PE advertising a MAC address for the first time advertises it with no MAC Mobility extended community attribute.
A PE detecting a locally attached MAC address for which it had previously received a MAC/IP Advertisement route with a different ESI advertises the MAC address in a MAC/IP Advertisement (Type-2) route tagged with a MAC Mobility extended community attribute with a sequence number one greater than the sequence number in the MAC Mobility extended community attribute of the received MAC/IP Advertisement route. In the case of the first mobility event for a given MAC address, where the received MAC/IP Advertisement route does not carry a MAC Mobility extended community attribute, the value of the sequence number in the received route is assumed to be 0 for the purpose of this processing.
A PE detecting a locally attached MAC address for which it had previously received a MAC/IP Advertisement route with the same non-zero Ethernet segment identifier advertises it with either (A) no MAC Mobility extended community attribute (if the received route did not carry said attribute), or (B) a MAC Mobility extended community attribute with the sequence number equal to the highest of the sequence number(s) in the received MAC/IP Advertisement route(s) (if the received route(s) is (are) tagged with a MAC Mobility extended community attribute).
A PE detecting a locally attached MAC address for which it had previously received a MAC/IP Advertisement route with the same zero ESI (single-homed scenarios) advertises it with a MAC Mobility extended community attribute with the sequence number set properly. In the case of single-homed scenarios, there is no need for ESI comparison. ESI comparison is done for multihoming to prevent false detection of MAC moves among the PEs attached to the same multihomed site.

A PE receiving a MAC/IP Advertisement (Type-2) route for a MAC address with a different ESI and a higher sequence number than that which it had previously advertised withdraws its MAC/IP Advertisement route. If two (or more) PEs advertise the same MAC address with the same sequence number but different ESIs, a PE that receives these routes selects the route advertised by the PE with the lowest IP address as the best route. If the PE is the originator of the MAC route and it receives the same MAC address with the same sequence number that it generated, it will compare its own IP address with the IP address of the remote PE and will select the lowest IP. If its own route is not the best one, it will withdraw the route.

### § 1.2.1.2.1.1 MAC DUPLICATION ISSUE(S)

A situation may arise where the same MAC address is learned by different PEs in the same VLAN (e.g., because of two (or more) hosts being misconfigured with the same (duplicate) MAC address, or because of a possible security attack). In such a situation(s), the traffic originating from these hosts would trigger continuous MAC moves among the PEs attached to these hosts. It is important to recognize such a situation and avoid incrementing the sequence number (in the MAC Mobility extended community attribute) to infinity (and generating wasteful control-plane signalling). In order to remedy such a situation, section 15.1 of RFC 7432 specifies that a PE that detects a MAC mobility event via local learning starts an M-second timer (with a default value of M=180), and if it detects a predetermined number (N) of MAC moves before the M-second timer expires (with a default value of N=5), it concludes that a “duplicate-MAC situation” has occurred. Per RFC 7432, in the duplicate-MAC situation, the PE alerts the operator and stops sending and processing any BGP MAC/IP Advertisement routes for that MAC address until a corrective action is taken by the operator. The values of M and N are configurable to allow for flexibility in operator control.

Note that the other PEs in the EVPN instance will forward the traffic for the duplicate MAC address to one of the PEs advertising the duplicate MAC address. The present inventors believe that this is problematic. Consider, for example, the example simple leaf and spine topology of FIG. 4. (Larger leaf and spine topologies, such as Clos topologies for example, are common in modern data centers (DCs).) As shown in FIG. 4, an example network 400 includes an EVPN 410 having a leaf and spine topology including Spine 1 420a, Spine 2 420b, Leaf 1 430a, Leaf 2 430b and Leaf 3 430c routers/switches and connected each other in a standard tier-2 model. All the leaf devices 430 are connected to both of the spine devices 420, as shown. EVPN service is hosted across Leaf 1 430a, Leaf 2 430b, and Leaf 3 430c, but not between Leaf 430 and Spine 420 (because most of the hosts will be behind Leafs, and MAC movements are frequent behind Leafs).

Still referring to FIG. 4, assume that the host (MAC) device 440 is a hacker, and moves between Leaf 2 430b and Leaf 3 430c quickly, as indicated by the double arrow dotted line. At some point in time, assume that Leaf 2 430b will mark this host as a “Duplicate MAC” (Recall section 15.1 of RFC 7432.) and, as a corrective action, will block traffic to and/or from the MAC address of 440. That is, assume that Leaf 2 430b will drop all traffic coming with the MAC address of 440 as a source or destination (as a preconfigured corrective action).

The present inventors have recognized that the corrective action taken by Leaf 2 430b is insufficient in some cases. For example, under the foregoing scenario, Leaf 1 430a still has the MAC route (for host 440) learned from Leaf 3 430c. Further, Leaf 3 430c also has the MAC route (for host 440) that it learned locally. Consequently, both Leaf 1 430a and Leaf 3 430c are unaware that the MAC address of host 440 is being blocked at Leaf 2 430b. The host 440 is behind Leaf 2 430b and in a blocked state. If any traffic arrives at Leaf 1 430a destined for the MAC of host 440, Leaf 1 430a will continue forward the traffic to Leaf 3 430c. Leaf 3 430c also will forward the traffic to the port associated with the MAC of host 440. The present inventors have recognized that this wastes network bandwidth and may create latency issues for other critical services.

### § 2. SUMMARY OF THE INVENTION

The problem of wasted network bandwidth within an EVPN network, in scenarios such as the one described with reference to FIG. 4, is solved by taking a corrective action with respect to the duplicate MAC (e.g., blocking the MAC) across the EVPN fabric, not only at the PE device that determined the MAC to be a duplicate MAC. That is, the problem of wasted network bandwidth within an Ethernet Virtual Private Network (EVPN), in scenarios in which a provider edge (PE) device detects a duplicate MAC but only performs a corrective action (e.g., blocking traffic sourced from and/or destined to the duplicate MAC) locally (at the PE that determined the duplicate MAC), is solved by taking a corrective action with respect to the MAC across the EVPN fabric. This may be done by having the PE device that determined a duplicate MAC to advertise this fact to other PE devices in the EVPN. This advertisement may be, or may be included in, a Type-2 MAC advertisement route (for example, in a MAC Mobility Extended Community path attribute, such as a set bit in the flags field of a MAC Mobility Extended Community path attribute).

Example embodiments consistent with the present description may provide an example method for use in a provider edge (PE) device in an Ethernet virtual private network (EVPN), the example method comprising: (a) receiving a packet including a media access control (MAC) address; (b) determining whether or not the MAC address received meets a MAC duplication test; and (c) responsive to determining that the MAC duplication test is met, (1) suppressing a route advertisement of the MAC address to at least one other PE device in the EVPN, (2) performing a configured corrective action with respect to the MAC address, and (3) advertising, in a message to the at least one other PE device in the EVPN, that it has determined that the MAC address is a duplicate. Otherwise, responsive to determining that the MAC duplication test is not met, the example method may include sending a route advertisement of the MAC address towards at least one other PE device in the EVPN.

In at least some example implementations of the example method, the PE device is a leaf node of a leaf and spine network.

In at least some example implementations of the example method, the advertisement is, or is included in, a Type-2 MAC advertisement route. For example, the advertisement may be, or may be included in, a MAC Mobility Extended Community path attribute. For example, the advertisement may be a set bit in the flags field of a MAC Mobility Extended Community path attribute.

In at least some example implementations of the example method, the example method further comprises: (d) receiving by the PE device, a route advertisement of the MAC address from one of the at least one other PE devices in the EVPN; and (e) responsive to receiving the route advertisement of the MAC address from the one of the at least one other PE devices in the EVPN, (1) determining whether or not the MAC address was already determined to be a duplicate that is subject to the configured corrective action, and (2) responsive to determining that the MAC address was determined to be a duplicate that is subject to the configured corrective action, sending a counter Type-2 MAC advertisement to the one of the at least one other PE devices in the EVPN, and otherwise, responsive to determining that the MAC address was not determined to be a duplicate, processing the route advertisement of the MAC address normally.

In at least some example implementations of the example method, the act of determining whether or not the MAC address received meets a MAC duplication test is performed by detecting whether or not at least a predetermined number (N) of MAC moves of the MAC address occur within a predetermined time period (e.g., M seconds).

In at least some example implementations of the example method, the configured corrective action with respect to the MAC address includes blocking traffic sourced from the MAC address and/or destined to the MAC address.

A non-transitory machine-readable medium stores processor-executable instructions which, when executed by at least one processor, cause the at least one processor to perform any of the example methods described.

Example embodiments consistent with the present description may provide an example provider edge (PE) device for use in an Ethernet virtual private network (EVPN), the PE device comprising: (a) at least one processor; and (b) a computer-readable storage medium storing instructions, which when executed by the at least one processor, cause the at least one processor to perform a method including (1) receiving a packet including a media access control (MAC) address, (2) determining whether or not the MAC address received meets a MAC duplication test, and (3) responsive to determining that the MAC duplication test is met, (A) suppressing a route advertisement of the MAC address to at least one other PE device in the EVPN, (B) performing a configured corrective action with respect to the MAC address, and (C) advertising, in a message to the at least one other PE device in the EVPN, that it has determined that the MAC address is a duplicate, and otherwise, responsive to determining that the MAC duplication test is not met, sending a route advertisement of the MAC address towards at least one other PE device in the EVPN.

The PE Device may be deployed as a leaf node of a leaf and spine network.

In some example implementations of the example PE device, the advertisement is, or is included in, a Type-2 MAC advertisement route. For example, the advertisement may be, or may be included in, a MAC Mobility Extended Community path attribute. For example, the advertisement may be a set bit in the flags field of a MAC Mobility Extended Community path attribute.

An example system consistent with the present description may be provided for use in an Ethernet virtual private network (EVPN). The example the system may comprise: (a) a first provider edge (PE) device configured to (1) receive a packet including a media access control (MAC) address, (2) determine whether or not the MAC address received meets a MAC duplication test, and (3) responsive to determining that the MAC duplication test is met, (A) suppress a route advertisement of the MAC address to at least one other PE device in the EVPN, (B) perform a first configured corrective action with respect to the MAC address, and (C) advertise, in a message to the at least one other PE device in the EVPN, that it has determined that the MAC address received meets the MAC duplication test, and otherwise, responsive to determining that the MAC duplication test is not met, send a route advertisement of the MAC address towards at least one other PE device in the EVPN; and (b) a second PE device configured to (1) receive the message advertised by the first PE device, and (2) responsive to receiving the message advertised by the first PE device, perform a second configured corrective action with respect to the MAC address.

In at least some example implementations of the example system, the first configured corrective action is the same as the second configured corrective action. For example, the first configured corrective action and the second configured corrective action may both include blocking traffic sourced from the MAC address, and/or destined to the MAC address.

In at least some other example implementations of the example system, the first configured corrective action is different from the second configured corrective action.

In at least some example implementations of the example system, the advertisement is, or is included in, a Type-2 MAC advertisement route. For example, the advertisement may be, or may be included in, a MAC Mobility Extended Community path attribute. For example, the advertisement may be a set bit in the flags field of a MAC Mobility Extended Community path attribute.

### § 3. BRIEF DESCRIPTION OF THE DRAWINGS

FIG. 1 illustrates the format of the EVPN NLRI, which is carried in an

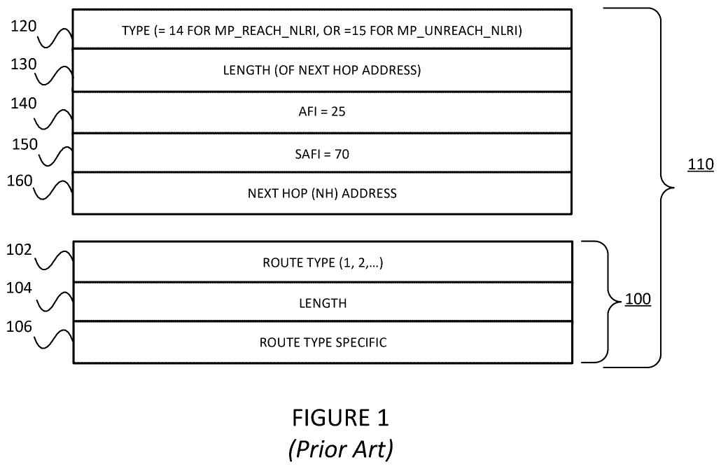

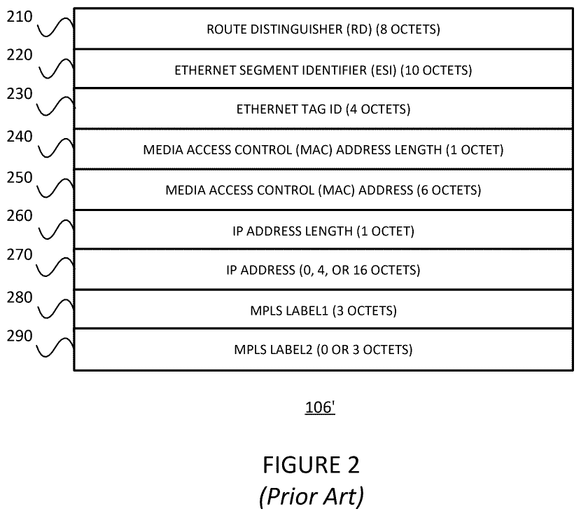

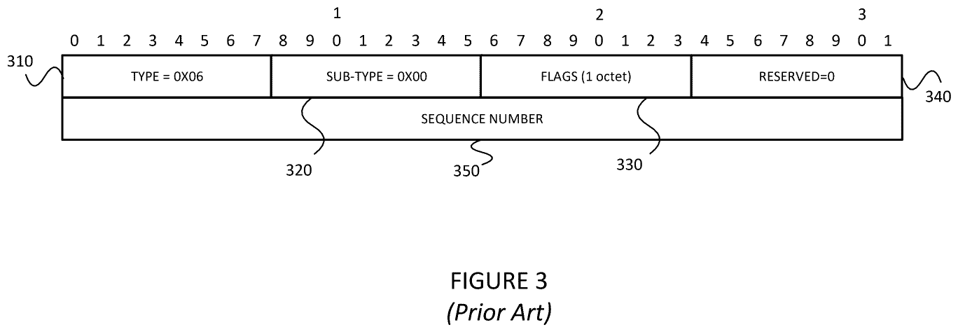

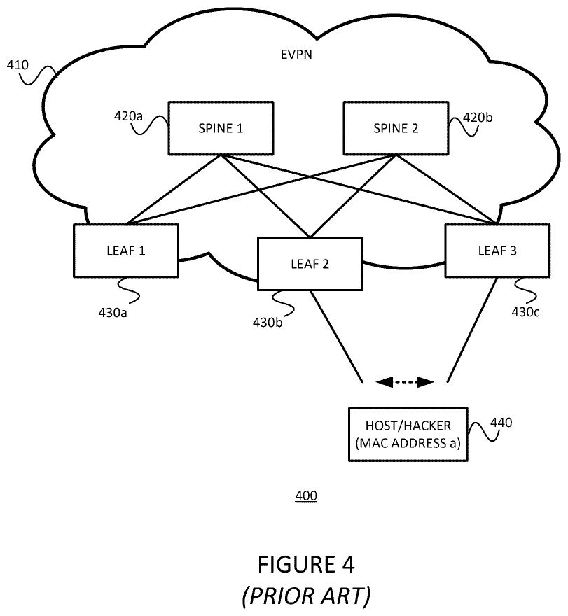

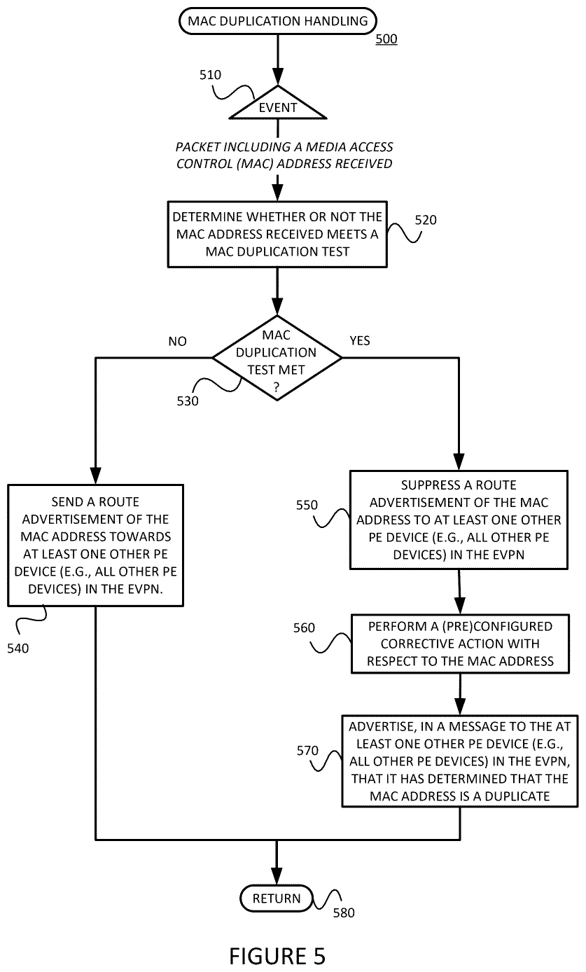

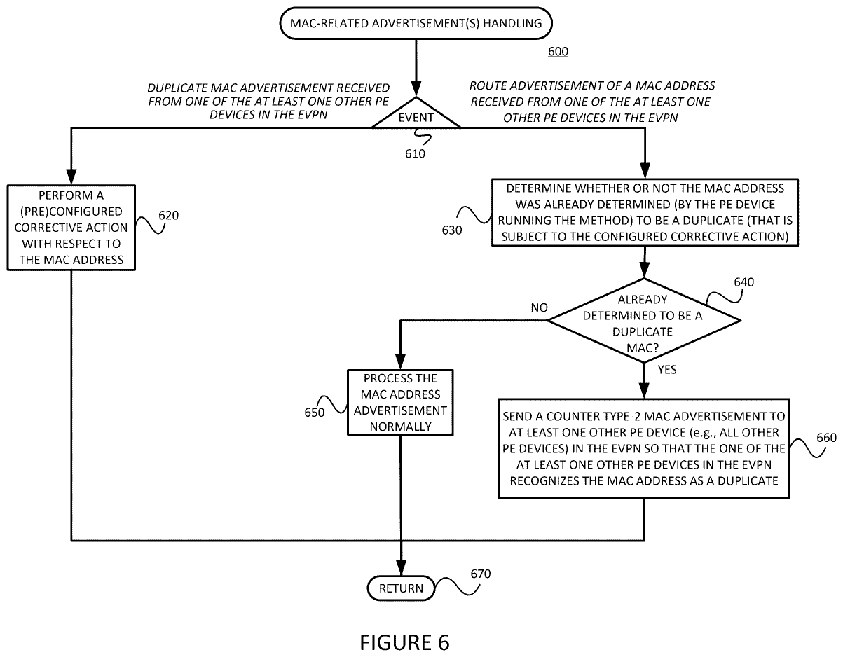

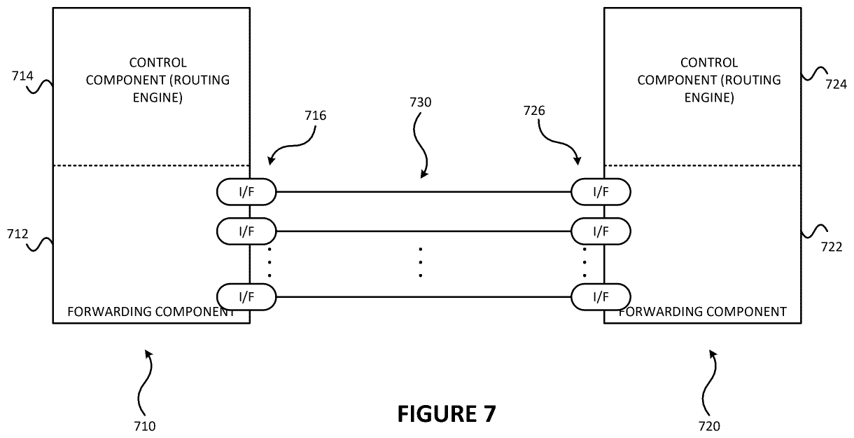

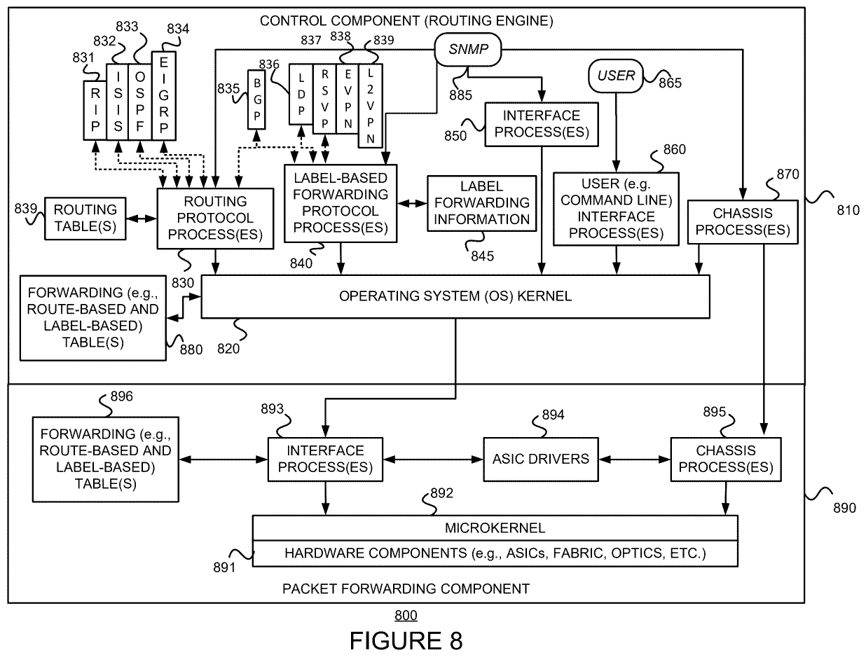

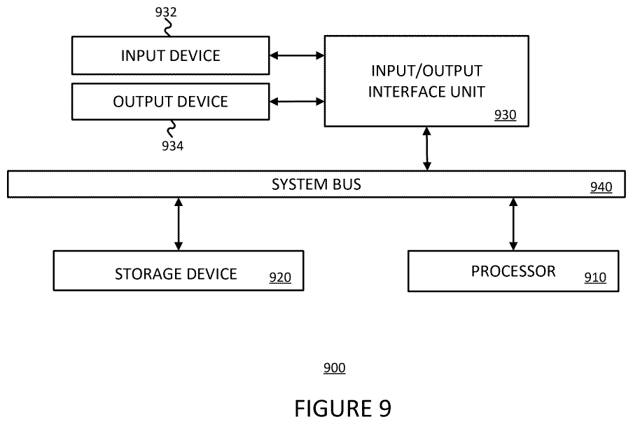

MP_REACH_NLRI or MP_UNREACH_NLRI.

### FIG. 2 Illustrates a MAC/IP Advertisement Route Type (type-2) specific EVPN NLRI, per RFC 7432.

FIG. 3 illustrates a MAC Mobility Extended Community per RFC 7432.

FIG. 4 is an example leaf and spine EVPN used to illustrate one or more problems

with existing EVPNs.

FIG. 5 is a flow diagram of an example method for handling a duplicate MAC (e.g., discovered by a PE locally) in a manner consistent with the present description.

FIG. 6 is a flow diagram of an example method 600 for handling a MAC-related advertisement(s) in a manner consistent with the present description.

FIG. 7 illustrates two data forwarding systems, which may be used as nodes, coupled via communications links, in a communications network, such as an EVPN.

FIG. 8 is a block diagram of a router which may be used a communications network,

such as an EVPN.

FIG. 9 is a block diagram of an exemplary machine that may perform one or more of the processes described, and/or store information used and/or generated by such processes.

### § 4. DETAILED DESCRIPTION

The present disclosure may involve novel methods, apparatus, message formats, and/or data structures to avoid wasted network bandwidth within an EVPN, in scenarios such as the one described above with reference to FIG. 4. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 4.1 DEFINITIONS AND ACRONYMS

Broadcast Domain: In a bridged network, the broadcast domain corresponds to a Virtual LAN (VLAN), where a VLAN is typically represented by a single VLAN ID (VID) but can be represented by several VIDs where Shared VLAN Learning (SVL) is used per [802.1Q].

CE or CE Device: Customer Edge device, e.g., a host, router, or switch.

EVI: An EVPN instance spanning the Provider Edge (PE) devices participating in that EVPN.

Ethernet Segment (ES): When a customer site (device or network) is connected to one or more PEs via a set of Ethernet links, then that set of links is referred to as an ‘Ethernet segment’.

Ethernet Segment Identifier (ESI): A unique non-zero identifier that identifies an Ethernet segment is called an ‘Ethernet Segment Identifier’.

Ethernet Tag: An Ethernet tag identifies a particular broadcast domain, e.g., a VLAN. An EVPN instance consists of one or more broadcast domains.

MAC-VRF: A Virtual Routing and Forwarding table for Media Access Control (MAC) addresses on a PE.

PE or PE Device: Provider Edge device, e.g., a router or switch.

### § 4.2 EXAMPLE METHOD(S)

FIG. 5 is a flow diagram of an example method 500 for handling a duplicate MAC (e.g., discovered locally by a PE in an EVPN) in a manner consistent with the present description. As shown, per the example method 500, the acts of the example method are triggered when the PE receives a packet including a media access control (MAC) address. (Event 510) (Note that if the MAC is learned locally, the source MAC is considered for Duplicate MAC detection, but if the MAC is learned via Type 2 messages, one can check for Duplicate on that MAC as well.) The example method 500 then determines whether or not the MAC address received meets a MAC duplication test. (Block 520). Responsive to determining that the MAC duplication test is met (Decision 530=YES), the example method 500 suppresses a route advertisement of the MAC address to at least one other PE device (e.g., all other PE devices) in the EVPN (Block 550), performs a configured (e.g., preconfigured) corrective action with respect to the MAC address (e.g., blocking traffic sourced from, and/or destined to, the MAC address) (Block 560), and advertises, in a message to the at least one other PE device (e.g., all other PE devices) in the EVPN, that it has determined that the MAC address is a duplicate (Block 570). Otherwise, responsive to determining that the MAC duplication test is not met (Decision 530=NO), the example method 500 sends a route advertisement of the MAC address towards at least one other PE device (e.g., all other PE devices) in the EVPN (e.g., per RFC 7432). (Block 540) The example method 500 is then left. (Node 580)

In some examples, the PE device performing the example method 500 is a leaf node of a leaf and spine network, such as a Clos network for example.

Referring back to blocks 540 and/or 570, in some example implementations of the example method 500, the advertisement is, or is included in, a Type-2 MAC advertisement route. (Recall, e.g., FIG. 2 and RFC 7432.) Referring back to block 570, in some example implementations of the example method 500, the advertisement (that a duplicate MAC address has been determined) is, or is included in, a MAC Mobility Extended Community path attribute. (Recall, e.g., FIG. 3 and RFC 7432.) In at least one such example implementation, the advertisement (that a duplicate MAC address has been determined) is indicated by setting a bit in the flags field of a MAC Mobility Extended Community path attribute. (Recall, e.g., 330 of FIG. 3.)

Referring back to block 520, in some example implementations of the example method 500, the act of determining whether or not the MAC address received meets a MAC duplication test is performed by detecting whether or not at least a predetermined number (N) of MAC moves of the MAC address occur within a predetermined time period (e.g., M seconds). The values of N and M may be configurable.

Referring back to block 560, in some example implementations of the example method 500, the configured (e.g., preconfigured) corrective action with respect to the MAC address includes blocking traffic sourced from the “duplicate” MAC address, and/or destined to the “duplicate” MAC address.

FIG. 6 is a flow diagram of an example method 600 for handling a MAC-related advertisement(s) (Recall, e.g., blocks 540 and 570 of FIG. 5.), in a manner consistent with the present description. Different branches of the example method 600 are performed responsive to the occurrence of different events. (Event branch point 610) Referring first to the left branch of the example method 600, responsive to receiving a duplicate MAC advertisement (Recall, e.g., block 570 of FIG. 5.) from one of the other PE device(s) in the EVPN, the example method 600 performs a configured (e.g., preconfigured) corrective action with respect to the MAC address. (Block 620) The example method 600 is then left. (Node 670)

Referring next to the right branch of the example method 600, responsive to receiving a route advertisement of a MAC address (Recall, e.g., block 540 of FIG. 5.) from one of the other PE device(s) in the EVPN, the example method 600 determines whether or not the MAC address advertised was already determined to be a duplicate that is subject to the configured (e.g., preconfigured) corrective action. (Block 630) If not (Decision 640=NO), the example method 600 simply processes the MAC address advertisement normally (e.g., per RFC 7432). (Block 650) The example method 600 is then left. (Node 670) If, on the other hand, it is determined that the MAC address advertised was already determined to be a duplicate (Decision 640=YES), the example method 600 sends a counter Type 2 MAC advertisement to at least one other PE device (e.g., all other PE devices, or all other PE devices that did not originate the route advertisement received) in the EVPN) in response. In this way, other PEs in the EVPN that might not implement the present methods 500 and/or 600 will forward traffic destined for the duplicate MAC to the PE that does implement the present methods. In this way, the PE implementing the present methods will perform the corrective action (e.g., drop the traffic) since it sees the MAC as a “duplicate” MAC. (Block 660) The example method 600 is then left. (Node 670) That is, block 660 of FIG. 6 can be used to help block a duplicate MAC in multi-vendor environment, in which some of the PE devices do not perform the example method 500 and/or the example method 600. An example illustrating this will be discussed in § 4.3 below with reference to FIGS. 4-6.

Referring back to block 620, in some example implementations of the example method 600, the configured (e.g., preconfigured) corrective action with respect to the MAC address includes blocking traffic sourced from the MAC address, and/or destined to the MAC address.

### § 4.3 EXAMPLE OPERATIONS OF EXAMPLE METHOD(S)

Referring back to FIG. 4, assume that the host (MAC) device 440 is a hacker, and moves between Leaf 2 430b and Leaf 3 430c quickly, as indicated by the double arrow dotted line. At some point in time, assume that Leaf 2 430b determines that this host as a “Duplicate MAC” (Recall, e.g., 530=YES in FIG. 5.) and, as a corrective action, will block traffic to and/or from the MAC address of 440 (Recall, e.g., block 560 of FIG. 5.). That is, assume that Leaf 2 430b will drop all traffic coming with the MAC address of 440 as a source or destination. Leaf 2 430b will also suppress a route advertisement of the MAC that would otherwise be sent to the other PE device(s) of the EVPN. (Recall, e.g., block 550 of FIG. 5.) Finally, Leaf 2 430b will advertise, to the other PE device(s) of the EVPN, that the MAC address is a duplicate. (Recall, e.g., block 570 of FIG. 5.)

Assume that a first of the other PE devices (e.g., Leaf 1) performs the example methods 500/600 described above. When Leaf 1 430a receives an advertisement of a duplicate MAC, it will perform a configured (e.g., preconfigured) corrective action (e.g., blocking traffic sourced from, and/or destined to, the duplicate MAC address. (Recall, e.g., block 620 of FIG. 6.)

Assume that a second of the other PE devices (e.g., Leaf 3) does not perform the example methods 500/600 described above. Assume that the host/MAC/hacker 440 moved to Leaf 3 430c. As a result, Leaf 3 430c will advertise that MAC to other Leaf nodes (e.g., per RFC 7432). When Leaf 2 430b receives such a Type-2 MAC route advertisement, it determines that it had already determined that the advertised MAC is a duplicate MAC. (Recall, e.g., block 630, and decision 640=YES in FIG. 6.) Leaf 2 430b will now send a counter Type-2 MAC route advertisement to Leaf 3 430c and other Leaf nodes. (Recall, e.g., block 660 of FIG. 6.) In this way, eventually, even leaf nodes that do not perform example methods 500 and/or 600 will send traffic destined for the duplicate MAC to Leaf 2 430b, which will block such traffic. Thus, as alluded to above, 630, 640 and 660 of FIG. 6 can help to block the MAC in multi-vendor environment (Recall that Leaf 3 430c does not perform the example methods 500/600, but performs in accordance with RFC 7432.)

Compare this with the standard “MAC Duplication Detection” feature of RFC 7432, which marks the MAC as “Duplicate MAC,” if the movement happens N times within M seconds (where M and N are user configurable). In existing scenarios, the device under test (DUT) which detects this “Duplicate MAC” suppresses the MAC route advertisement to remote PE devices and also performs the configured corrective action (e.g., blocking the traffic on the PE (DUT) for that MAC (source or destination)). Although the duplicate MAC is blocked from one leaf, the EVPN fabric still forwards the traffic to the leaf, even though the host 440 might not be present. If this is a rogue host, traffic sourced from, or destined to, the rogue host 440 should not be forwarded across the EVPN fabric. Example embodiments consistent with the present description further prevent this duplicate MAC, across EVPN fabric, from sending or receiving traffic. In some example implementations, the “MAC Mobility Extended Community” path attribute's FLAG field may include bit (call it a “duplicate” bit) set to convey that MAC was determined to be a duplicate, and is subject to a corrective action (e.g., blocked) to the other Leaf devices. The sequence number may be an increased number from the past learning (e.g., per RFC 7432).

As demonstrated by the foregoing example, if the (user configurable) corrective action is to block traffic sourced from and/or destined to, the duplicate MAC, leaf 1 430a and leaf 3 430c will also block the traffic (that is, these leaf nodes won't forward or receive the traffic for the duplicate MAC), assuming that both of these leaf nodes implement the example methods described. If not, traffic destined for the MAC is forwarded to a leaf node that implements the example method and blocks the traffic. This solution will improve the network bandwidth utilization by preventing unauthorised MAC's traffic in the EVPN fabric (compared with just at any leaf nodes that determine that the MAC is a duplicate MAC) and allows better service to be provided to the customers.

If there is auto-recovery, or the MAC ages out, or if someone clears the bridge MAC-table, on a given PE device there will be Type-2 MAC route withdraw followed by Type-2 MAC route advertisement with appropriate mobility community (if applicable) when the MAC is freshly learned on that PE device.

### § 4.4 EXAMPLE APPARATUS

The data communications network nodes (e.g., PE devices, leaf nodes, spine nodes, etc.) may be forwarding devices, such as routers for example. FIG. 7 illustrates two data forwarding systems 710 and 720 coupled via communications links 730. The links may be physical links or “wireless” links. The data forwarding systems 710, 720 may be routers for example. If the data forwarding systems 710, 720 are example routers, each may include a control component (e.g., a routing engine) 714, 724 and a forwarding component 712,722. Each data forwarding system 710,720 includes one or more interfaces 716,726 that terminate one or more communications links 730.

As just discussed above, and referring to FIG. 8, some example routers 800 include

a control component (e.g., routing engine) 810 and a packet forwarding component (e.g., a packet forwarding engine) 890.

The control component 810 may include an operating system (OS) kernel 820, routing protocol process(es) 830, label-based forwarding protocol process(es) 840, interface process(es) 850, user interface (e.g., command line interface) process(es) 860, and chassis process(es) 870, and may store routing table(s) 839, label forwarding information 845, and forwarding (e.g., route-based and/or label-based) table(s) 880. As shown, the routing protocol process(es) 830 may support routing protocols such as the routing information protocol (“RIP”) 831, the intermediate system-to-intermediate system protocol (“IS-IS”) 832, the open shortest path first protocol (“OSPF”) 833, the enhanced interior gateway routing protocol (“EIGRP”) 834 and the border gateway protocol (“BGP”) 835, and the label-based forwarding protocol process(es) 840 may support protocols such as BGP 835, the label distribution protocol (“LDP”) 836, the resource reservation protocol (“RSVP”) 837, EVPN 838 and L2VPN 839. One or more components (not shown) may permit a user 865 to interact with the user interface process(es) 860. Similarly, one or more components (not shown) may permit an outside device to interact with one or more of the router protocol process(es) 830, the label-based forwarding protocol process(es) 840, the interface process(es) 850, and the chassis process(es) 870, via SNMP 885, and such processes may send information to an outside device via SNMP 885.

The packet forwarding component 890 may include a microkernel 892 over hardware

components (e.g., ASICs, switch fabric, optics, etc.) 891, interface process(es) 893, ASIC drivers 894, chassis process(es) 895 and forwarding (e.g., route-based and/or label-based) table(s) 896.

In the example router 800 of FIG. 8, the control component 810 handles tasks such as performing routing protocols, performing label-based forwarding protocols, control packet processing, etc., which frees the packet forwarding component 890 to forward received packets quickly. That is, received control packets (e.g., routing protocol packets and/or label-based forwarding protocol packets) are not fully processed on the packet forwarding component 890 itself, but are passed to the control component 810, thereby reducing the amount of work that the packet forwarding component 890 has to do and freeing it to process packets to be forwarded efficiently. Thus, the control component 810 is primarily responsible for running routing protocols and/or label-based forwarding protocols, maintaining the routing tables and/or label forwarding information, sending forwarding table updates to the packet forwarding component 890, and performing system management. The example control component 810 may handle routing protocol packets, provide a management interface, provide configuration management, perform accounting, and provide alarms. The processes 830, 840, 850, 860 and 870 may be modular, and may interact with the OS kernel 820. That is, nearly all of the processes communicate directly with the OS kernel 820. Using modular software that cleanly separates processes from each other isolates problems of a given process so that such problems do not impact other processes that may be running. Additionally, using modular software facilitates easier scaling.

Still referring to FIG. 8, the example OS kernel 820 may incorporate an application programming interface (“API”) system for external program calls and scripting capabilities. The control component 810 may be based on an Intel PCI platform running the OS from flash memory, with an alternate copy stored on the router's hard disk. The OS kernel 820 is layered on the Intel PCI platform and establishes communication between the Intel PCI platform and processes of the control component 810. The OS kernel 820 also ensures that the forwarding tables 896 in use by the packet forwarding component 890 are in sync with those 880 in the control component 810. Thus, in addition to providing the underlying infrastructure to control component 810 software processes, the OS kernel 820 also provides a link between the control component 810 and the packet forwarding component 890.

Referring to the routing protocol process(es) 830 of FIG. 8, this process(es) 830 provides routing and routing control functions within the platform. In this example, the RIP 831, ISIS 832, OSPF 833 and EIGRP 834 (and BGP 835) protocols are provided. Naturally, other routing protocols may be provided in addition, or alternatively. Similarly, the label-based forwarding protocol process(es) 840 provides label forwarding and label control functions. In this example, the LDP 836, RSVP 837, EVPN 838 and L2VPN 839 (and BGP 835) protocols are provided. Naturally, other label-based forwarding protocols (e.g., MPLS, SR, etc.) may be provided in addition, or alternatively. In the example router 800, the routing table(s) 839 is produced by the routing protocol process(es) 830, while the label forwarding information 845 is produced by the label-based forwarding protocol process(es) 840.

Still referring to FIG. 8, the interfacepProcess(es) 850 performs configuration of the physical interfaces and encapsulation.

The example control component 810 may provide several ways to manage the router. For example, it 810 may provide a user interface process(es) 860 which allows a system operator 865 to interact with the system through configuration, modifications, and monitoring. The SNMP 885 allows SNMP-capable systems to communicate with the router platform. This also allows the platform to provide necessary SNMP information to external agents. For example, the SNMP 885 may permit management of the system from a network management station running software, such as Hewlett-Packard's Network Node Manager (“HP-NNM”), through a framework, such as Hewlett-Packard's OpenView. Accounting of packets (generally referred to as traffic statistics) may be performed by the control component 810, thereby avoiding slowing traffic forwarding by the packet forwarding component 890.

Although not shown, the example router 800 may provide for out-of-band management, RS-232 DB9 ports for serial console and remote management access, and tertiary storage using a removable PC card. Further, although not shown, a craft interface positioned on the front of the chassis provides an external view into the internal workings of the router. It can be used as a troubleshooting tool, a monitoring tool, or both. The craft interface may include LED indicators, alarm indicators, control component ports, and/or a display screen. Finally, the craft interface may provide interaction with a command line interface (“CLI”) 860 via a console port, an auxiliary port, and/or a management Ethernet port.

The packet forwarding component 890 is responsible for properly outputting received packets as quickly as possible. If there is no entry in the forwarding table for a given destination or a given label and the packet forwarding component 890 cannot perform forwarding by itself, it 890 may send the packets bound for that unknown destination off to the control component 810 for processing. The example packet forwarding component 890 is designed to perform Layer 2 and Layer 3 switching, route lookups, and rapid packet forwarding.

As shown in FIG. 8, the example packet forwarding component 890 has an embedded microkernel 892 over hardware components 891, interface process(es) 893, ASIC drivers 894, and chassis process(es) 895, and stores a forwarding (e.g., route-based and/or label-based) table(s) 896. The microkernel 892 interacts with the interface process(es) 893 and the chassis process(es) 895 to monitor and control these functions. The interface process(es) 892 has direct communication with the OS kernel 820 of the control component 810. This communication includes forwarding exception packets and control packets to the control component 810, receiving packets to be forwarded, receiving forwarding table updates, providing information about the health of the packet forwarding component 890 to the control component 810, and permitting configuration of the interfaces from the user interface (e.g., CLI) process(es) 860 of the control component 810. The stored forwarding table(s) 896 is static until a new one is received from the control component 810. The interface process(es) 893 uses the forwarding table(s) 896 to look up next-hop information. The interface process(es) 893 also has direct communication with the distributed ASICs. Finally, the chassis process(es) 895 may communicate directly with the microkernel 892 and with the ASIC drivers 894.

The example methods 500 and 600 may be implemented within the BGP 835, the EVPN 838, and/or the L2VPN 839 processes.

Although example embodiments consistent with the present description may be implemented on the example routers of FIG. 7 or 8, embodiments consistent with the present description may be implemented on communications network nodes (e.g., routers, switches, etc.) having different architectures. More generally, embodiments consistent with the present description may be implemented on an example system 900 as illustrated on FIG. 9.

FIG. 9 is a block diagram of an exemplary machine 900 that may perform one or more of the processes described, and/or store information used and/or generated by such processes. The exemplary machine 900 includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930. The one or more processors 910 may execute machine-executable instructions (e.g., C or C++running on the Linux operating system widely available from a number of vendors) to effect one or more aspects of the present description. At least a portion of the machine executable instructions may be stored (temporarily or more permanently) on the one or more storage devices 920 and/or may be received from an external source via one or more input interface units 930. The machine executable instructions may be stored as various software modules, each module performing one or more operations. Functional software modules are examples of components of the present description.

In some embodiments consistent with the present description, the processors 910 may be one or more microprocessors and/or ASICs. The bus 940 may include a system bus. The storage devices 920 may include system memory, such as read only memory (ROM) and/or random access memory (RAM). The storage devices 920 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMs, EPROMs, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, one or more network processors, etc. Alternatively, or in addition, embodiments consistent with the present description (or components or modules thereof) might be implemented as stored program instructions executed by a processor. Such hardware and/or software might be provided in an addressed data (e.g., packet, cell, etc.) forwarding device (e.g., a switch, a router, etc.), a laptop computer, desktop computer, a tablet computer, a mobile phone, or any device that has computing and networking capabilities.

### § 4.5 CONCLUSIONS

Blocking unauthorised users and preserving the network bandwidth by reducing or restricting unwanted traffic are the important goals for any network service providers as well as for AI Datacentres vendors. Example embodiments consistent with the present description can be used to block an unauthorized user across EVPN fabric automatically. Blocking unwanted traffic into the EVPN fabric in a manner consistent with the example embodiments described saves bandwidth.

What is claimed is:

1. For use in a provider edge (PE) device in an Ethernet virtual private network (EVPN), a computer-implemented method comprising:
a) receiving a packet including a media access control (MAC) address;
b) determining whether or not the MAC address received meets a MAC duplication test; and
c) responsive to determining that the MAC duplication test is met,
1) suppressing a route advertisement of the MAC address to at least one other PE device in the EVPN,
2) performing a configured corrective action with respect to the MAC address, and
3) advertising, in a message to the at least one other PE device in the EVPN, that it has determined that the MAC address is a duplicate, and
otherwise, responsive to determining that the MAC duplication test is not met, sending a route advertisement of the MAC address towards at least one other PE device in the EVPN.

2. The computer-implemented method of claim 1, wherein the PE device is a leaf node of a leaf and spine network.

3. The computer-implemented method of claim 1, wherein the advertisement is, or is included in, a Type-2 MAC advertisement route.

4. The computer-implemented method of claim 3, wherein the advertisement is, or is included in, a MAC Mobility Extended Community path attribute.

5. The computer-implemented method of claim 3, wherein the advertisement is a set bit in the flags field of a MAC Mobility Extended Community path attribute.

6. The computer-implemented method of claim 1, further comprising:
d) receiving by the PE device, a route advertisement of the MAC address from one of the at least one other PE devices in the EVPN; and
e) responsive to receiving the route advertisement of the MAC address from the one of the at least one other PE devices in the EVPN,
1) determining whether or not the MAC address was already determined to be a duplicate that is subject to the configured corrective action, and
2) responsive to determining that the MAC address was determined to be a duplicate that is subject to the configured corrective action, sending a counter Type-2 MAC advertisement to the one of the at least one other PE devices in the EVPN, and
otherwise, responsive to determining that the MAC address was not determined to be a duplicate, processing the route advertisement of the MAC address normally.

7. The computer-implemented method of claim 1, wherein the act of determining whether or not the MAC address received meets a MAC duplication test is performed by detecting whether or not at least a predetermined number of MAC moves of the MAC address occur within a predetermined time period.

8. The computer-implemented method of claim 1, wherein the configured corrective action with respect to the MAC address includes blocking traffic sourced from the MAC address and/or destined to the MAC address.

9. A provider edge (PE) device for use in an Ethernet virtual private network (EVPN), the PE device comprising:
a) at least one processor; and
b) a computer-readable storage medium storing instructions, which when executed by the at least one processor, cause the at least one processor to perform a method including
1) receiving a packet including a media access control (MAC) address,
2) determining whether or not the MAC address received meets a MAC duplication test, and
3) responsive to determining that the MAC duplication test is met,
A) suppressing a route advertisement of the MAC address to at least one other PE device in the EVPN,
B) performing a configured corrective action with respect to the MAC address, and
C) advertising, in a message to the at least one other PE device in the EVPN, that it has determined that the MAC address is a duplicate, and
otherwise, responsive to determining that the MAC duplication test is not met, sending a route advertisement of the MAC address towards at least one other PE device in the EVPN.

10. The PE device claim 9, wherein the PE device is a leaf node of a leaf and spine network.

11. The PE device of claim 9, wherein the advertisement is, or is included in, a Type-2 MAC advertisement route.

12. The PE device of claim 11, wherein the advertisement is, or is included in, a MAC Mobility Extended Community path attribute.

13. The PE device of claim 11, wherein the advertisement is a set bit in the flags field of a MAC Mobility Extended Community path attribute.

14. A system for use in an Ethernet virtual private network (EVPN), the system comprising:
a) a first provider edge (PE) device configured to
1) receive a packet including a media access control (MAC) address,
2) determine whether or not the MAC address received meets a MAC duplication test, and
3) responsive to determining that the MAC duplication test is met,
A) suppress a route advertisement of the MAC address to at least one other PE device in the EVPN,
B) perform a first configured corrective action with respect to the MAC address, and
C) advertise, in a message to the at least one other PE device in the EVPN, that it has determined that the MAC address received meets the MAC duplication test, and
otherwise, responsive to determining that the MAC duplication test is not met, send a route advertisement of the MAC address towards at least one other PE device in the EVPN; and
b) a second PE device configured to
1) receive the message advertised by the first PE device, and
2) responsive to receiving the message advertised by the first PE device, perform a second configured corrective action with respect to the MAC address.

15. The system of claim 14 wherein the first configured corrective action is the same as the second configured corrective action.

16. The system of claim 15, wherein the first configured corrective action and the second configured corrective action include blocking traffic sourced from the MAC address or destined to the MAC address.

17. The system of claim 14, wherein the first configured corrective action is different from the second configured corrective action.

18. The system of claim 14, wherein the advertisement is, or is included in, a Type-2 MAC advertisement route.

19. The system of claim 18, wherein the advertisement is, or is included in, a MAC Mobility Extended Community path attribute.

20. The system of claim 18, wherein the advertisement is a set bit in the flags field of a MAC Mobility Extended Community path attribute.
